(19) United States
(12) Patent Application Publication
(10) Pub. No.: US 2014/0337110 A1
(43) Pub. Date: Nov. 13, 2014

(54) Method And System For Determining Average Values For Displayed Information Items

(71) Applicant: RetailMeNot, Inc., Austin, TX (US)

(72) Inventor: Guy Phillip William King, Prahran (AU)

(21) Appl. No.: 14/445,801

(22) Filed: Jul. 29, 2014

Related U.S. Application Data
(63) Continuation of application No. 12/840,947, filed on Jul. 21, 2010.
(60) Provisional application No. 61/347,100, filed on May 21, 2010.

(51) Int. Cl. G06Q 30/02

(52) U.S. Cl. CPC G06Q 30/0211
USPC 705/14.13

(57) ABSTRACT

A method of displaying information items, the method comprising determining an average value for each of a plurality of information items based on at least one stored input value received for each of the information items; determining, responsive to a first serve request and based on at least one display criterion, at least one of the information items to be displayed at a client device; and transmitting to the client device code executable by a browser application to display the at least one information item and the average value determined for each at least one information item.

### RELATED APPLICATION

This application hereby claims priority under 35 U.S.C. §119 to U.S. Provisional Application No. 61/347,100, entitled “Method and System for Determining Average Values for Displayed Information Items,” by Guy Phillip William King, filed 21 May 2010 (Atty. Docket No.: DCC-30934705PRO).

### TECHNICAL FIELD

The described embodiments relate generally to methods and systems for determining average values for displayed information items. Particular embodiments involve display of information items on a website together with average values for each of the items based on feedback input received in relation to the items.

### BACKGROUND

Coupons can be used as a form of information item to induce a potential customer to purchase a product or service. For example, the information item may be framed as a promotional offer that involves providing a product or service at a discounted price and this can be represented in the form of a coupon having a coupon code. The coupon code may be used by the entity making the promotional offer to validate the coupon.

Some coupons may be made available on a website, from which the coupons may be printed for physical presentation of the coupon at a retail establishment or, in some instances, for presentation when making an online purchase of a product or service to which the coupon applies.

In displaying information items on a website, users navigating to the site may enjoy a better user experience if they are able to view aggregated feedback input from other users in relation to displayed information items.

### SUMMARY

Some embodiments relate to a method of displaying information items, the method comprising:

determining an average value for each of a plurality of previously displayed information items based on at least one stored input value received for each of the information items;

determining, responsive to a first serve request and based on at least one display criterion, at least one of the information items to be displayed at a client device; and

transmitting to the client device code executable by a browser application to display the at least one information item and the average value determined for each at least one information item.

Determining the average may comprise filtering the at least one input value according to at least one filter criterion. The filtering may comprise removing input values not meeting the at least one criterion from calculation of the average. The at least one filter criterion may include a first filter criterion that each input value does not exceed a first proportion of the average of all other input values received in relation to the information item. The at least one filter criterion may include a second filter criterion that each input value is not less than a second proportion of the average of all other input values received in relation to the information item. The at least one filter criterion may include a third filter criterion that each input value does not exceed a third proportion of a previously calculated average of input values received in relation to a group of information items, for example such as information items offered by a same information item offeror.

Determining the average value may comprise, for each input value received in respect of an information item, determining whether the input value falls within an acceptable value range that may be calculated as a function of all other input values received in respect of that information item, and excluding input values not within the acceptable value range from calculation of the average value.

The average value may be a first average value and the transmitted code may include code to display a second average value of filtered input values received in relation to all information items offered by a same information item offeror. The filtered input values may comprise a filtered set of all input values received in relation to all information items offered by the same information item offeror. The second average value may be displayed in a banner section of an offeror-specific display which may be generated by the browser application based on the transmitted code.

The method may further comprise receiving voting information in relation to each information item and storing in a database voting data based on the voting information in a data record associated with the information item. The voting data may comprise for each vote a Boolean value and a date and time at which the vote was received. The input values may be received only in respect of information items for which voting information is received. Receipt of an input value may cause a flag to be set in a database record of the information item, thereby indicating that an updated average value should be calculated for that information item the next time the average values are recalculated.

Determining the average may be performed at regular intervals as part of an average recalculation/updating process, for example every time a predetermined period of minutes, hours or days has passed since the last average recalculation.

The at least one criterion may comprise a criterion or selection input received from the client device with the first serve request. For example, the criterion or selection input may relate to a specific information item offeror and the responsive display of information items may then comprise information items offered, sponsored or authored by that offeror.

The method may further comprise receiving at a server system associated with a host site a second serve request indicating a first uniform resource locator (URL) unique to one displayed information item described in the code transmitted to the client device. The method may further comprise automatically redirecting the second serve request to a second URL associated with an offeror of the one information item, the second URL being unique to the host site and the offeror. The method may perform a look-up based on the first URL to determine the second URL and may store a record of the receiving of the second serve request.

The information items may comprise at least one of promotional offers and shopping tips and the stored input values may be values indicative of monetary savings reported by users for the promotional offer or shopping tip. Each information item may comprise a feedback section and the transmitted code may comprise code to cause an input value solicitation window to be displayed in response to selection of a feedback item, such as a positive feedback button, in the feedback section. The browser-executable code may be configured so that values input into one or more value fields in the input solicitation window are sent by the browser application to the server system, for example by a client-side applet, in response to a user submission or action interpreted to be indicative of an intention to submit the input value. The intention to submit may be indicated by clicking on a selectable option or hitting an enter or carriage return button on the client device, for example.

Some embodiments relate to a display method, comprising:

determining a group average for each of a plurality of groups of previously displayed information items based on at least one stored input value received in relation to one or more of the information items in the respective group;

determining, responsive to a serve request, a group-related display to be provided to a client device in relation to at least one of the groups; and transmitting to the client device code executable by a browser application to display the group-related display and the respective group average for the at least one group.

The browser-executable code may cause a group average of nil value to be excluded from display. The group average for each group may be determined based on a filtered set of stored input values received in relation to the one or more information items.

Determining the group average may comprise filtering the at least one input value according to at least one filter criterion. The filtering may comprise removing input values not meeting the at least one filter criterion from calculation of the average. The at least one filter criterion may include a first criterion that each input value does not exceed a first proportion of the average of all other input values received in relation to the information item. The first proportion may be about 300%.

The at least one filter criterion may include a second criterion that each input value is not less than a second proportion of the average of all other input DCC-3099729 application 5 values received in relation to the information item. The second proportion may be about 50%. The at least one filter criterion may include a third criterion that each input value does not exceed a third proportion of a previously calculated average of input values received in relation to information items offered by a same information item offeror. The third proportion may be about 200%.

The code, when executed by the browser application, may cause the group average to be displayed in a banner area of the group-related display. The group related display may comprise a display of at least one information item of one group of information items. The display of at least one information item may comprise a display of an average value of stored input values received in relation to the respective at least one information item.

The group average may be an average value selected from the group consisting of: a mean value of stored input values; a median value of stored input values; and a mode value of stored input values. The average value for an information item may be selected from the group consisting of: a mean value of stored input values; a median value of stored input values; and a mode value of stored input values.

An input value received via the input value solicitation window may be stored in relation to the information item for which it was received for possible use in determining the average value.

Some embodiments relate to computer-readable storage storing executable program code which, when executed by at least one processor, causes the at least one processor to perform the methods herein described.

Some embodiments relate to a server system comprising:

at least one processing device; and

computer-readable storage storing executable instructions which, when executed by the at least one processing device, causes the server system to perform the methods herein described.

Some embodiments relate to a client computing device executing served code to perform methods described herein.

### BRIEF DESCRIPTION OF THE DRAWINGS

Embodiments are described in further detail below, by way of example, with reference to the accompanying drawings, in which:

FIG. 1 is a block diagram of an example client-server architecture;

FIG. 2 is a block diagram showing aspects of the client-server architecture in further detail;

FIG. 3 is a block diagram of an example computing device;

FIG. 4 is a flow chart of a method for displaying information items;

FIGS. 5A and 5B illustrate a flow chart of a method of determining an average value for an information item and groups of information items based on user feedback;

FIG. 6 is an example display of an information item according to some embodiments;

FIG. 7 is an example display of an input invitation according to some embodiments;

FIG. 8 is an example display of a banner area for a list of information items according to some embodiments; and

FIG. 9 is a flow chart of a method of receiving user feedback in relation to a displayed information item.

### DETAILED DESCRIPTION

Described embodiments relate generally to methods and systems involving the display of information items. The information items may facilitate access to one or more promotional offers. An information item may be one of many provided on a website that specialises in making large numbers of promotional offers available to consumers to redeem at many different retailers. The promotional offers may be presented in the form of a coupon, for example. In other embodiments, the information items may relate to plug-ins, updates or patches for computer security software, for example. However, for convenient illustration, examples are described herein in relation to embodiments relating to promotional offers and shopping tips.

A user may navigate to a coupon-sharing website, for example, where promotional offers in the form of coupons from many different retailers or service providers may be displayed and searched. Although it is common to describe web pages as being displayed on a website, the actual display occurs using a browser application on a client computing device that receives code from a web server hosting the website in response to a serve request for a web “page”. At least some of the code thus received by the client computing device is then executed by the browser application, if possible, to display the requested web page. The code may also include script that is executable by the browser application in response to user selections received in relation to the images and objects displayed. It is in this context that embodiments are further described.

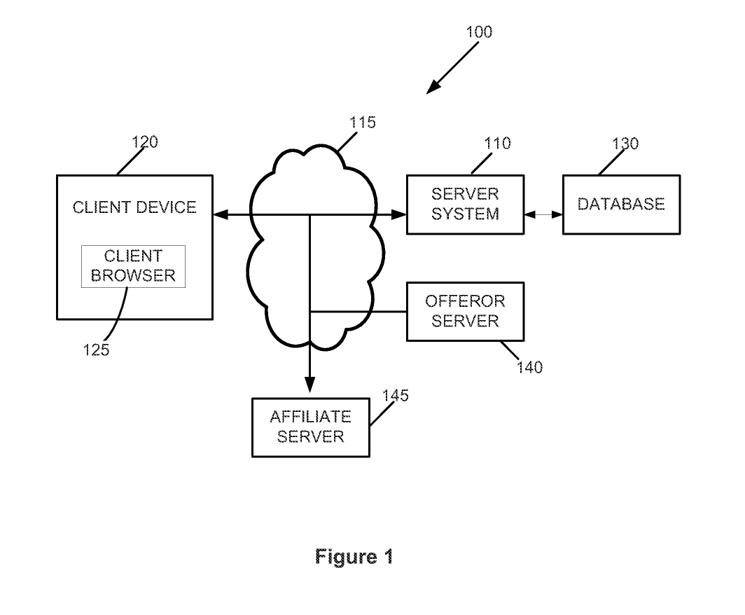

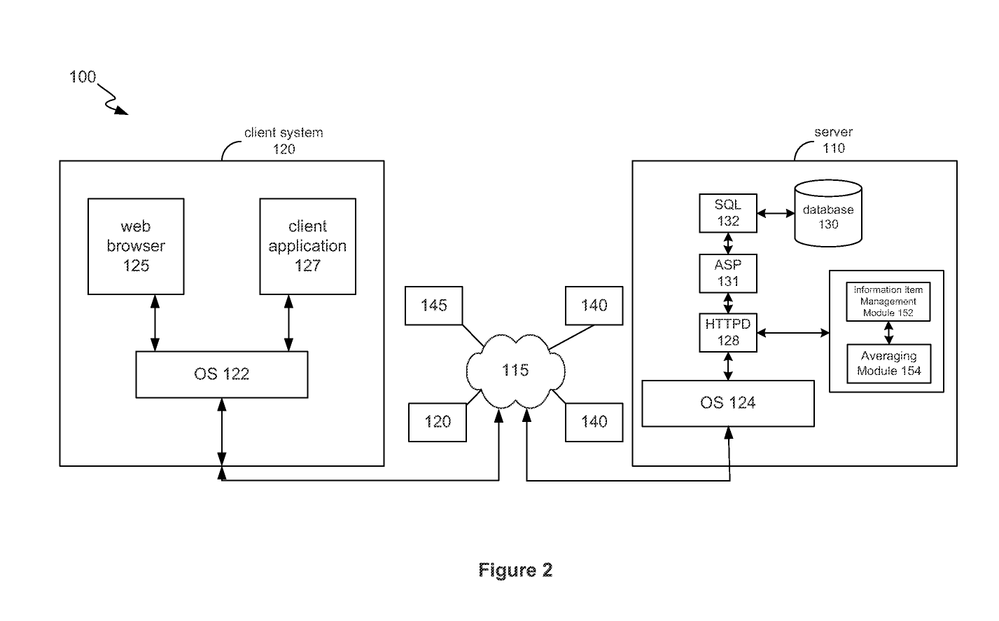

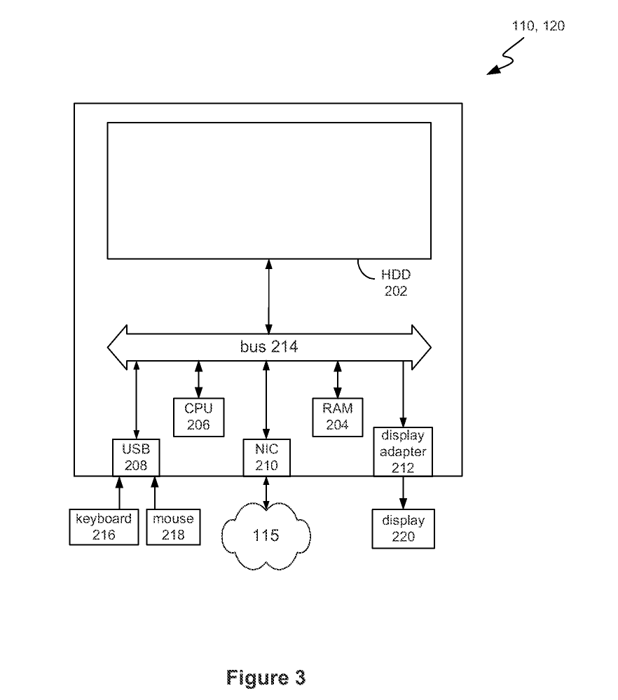

Referring generally to FIG. 1, a system 100 for facilitating access to information items, such as a promotional offer or shopping tip, is described in further detail. Aspects of system 100 are also shown and described by way of example with reference to FIGS. 2 and 3. System 100 comprises a server system 110 and a client computing device 120 in communication with each other over a network 115, such as the Internet. System 100 further comprises a DCC-3099729 application 8 database 130 accessible to server system 110 for storing data pertinent to operation of server system 110 and provision of service to client computing device 120. System 100 further comprises an offeror server 140 and an affiliate server 145 in communication with server system 110 and client computing device 120 over network 115.

Client computing device 120 may comprise a desktop, mobile or handheld computing device having at least one processor (e.g. CPU 206), one or more forms of memory 202, 204, an operating system 122 and a user interface. The memory may comprise volatile (e.g. RAM 204) and non-volatile (e.g. hard disk drive 202, solid state drive, Flash memory and/or optical disc) storage. The user interface may comprise a display 220 and at least one input device, such as a touch-screen, a keyboard 216, mouse 218, stylus or other peripheral device that can be used for providing user input to client computing device 120.

A number of software applications or applets may be executing or executable by the at least one processor to perform various device-related functions. Such applications may be stored in the non-volatile memory 202 of computing device 120 and applets may be stored in volatile memory 204, for example. At least one such software application includes a browser application 125 for enabling a user to navigate to sites accessible over the network 115 to receive content therefrom. Other client software applications 127 may execute on client system 120 using operating system 122.

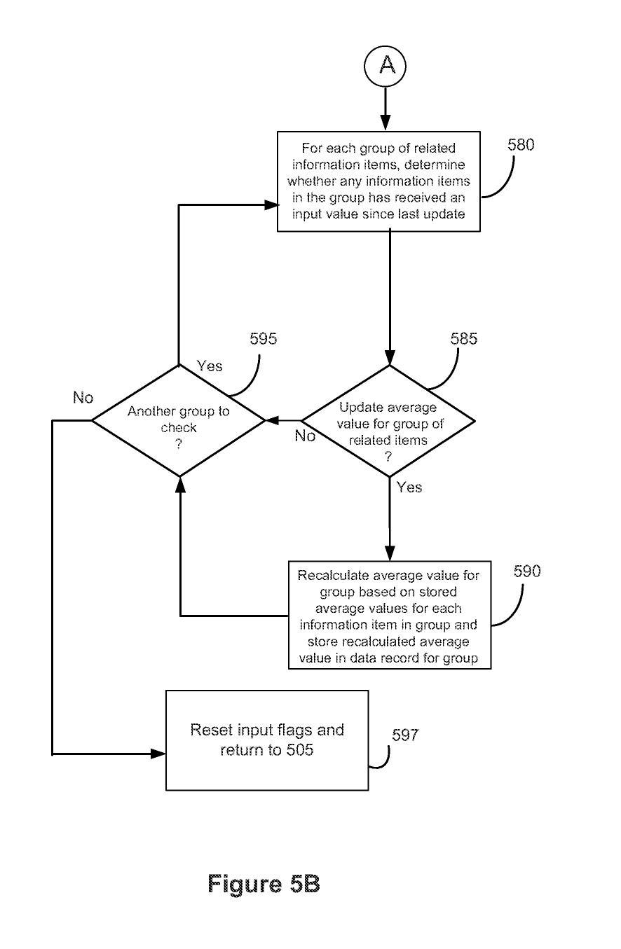

In the example of system 100 illustrated in FIG. 1, client browser 125 can be used to communicate with server system 110 to request content therefrom, in the form of one or more web pages provided as program code executable by the browser application 125. According to some embodiments, server system 110 is configured to provide at least one promotional offer, and more likely many such promotional offers, for consideration by a user viewing web pages via browser application 125 and to facilitate the sharing of such promotional offers by users. Thus, server system 110 may support or act as a coupon, promotional offer or other information items sharing site. FIGS. 6, 7 and 8 illustrate example displays 600, 700 and 800 relating to promotional offers and shopping tips (as exemplary forms of information items) displayable by browser application 125 according to code received from server system 110.

Server system 110 may display (or have accessible for display) a large number of promotional offers, shopping tips or other information items, one or more of which may be offered by or associated with a product or service provider or an onseller or reseller (i.e. as a subject party of the information item) of such products or services (i.e. a retailer), termed herein for convenience as the “offeror”. The offeror server 140 may thus comprise a web server hosted by or on behalf of the offeror and making available web pages associated with the product or service to which the promotional offer or other information item (viewable by the user by accessing server system 110) relates. The promotional offer may thus be used as a means of, among other things, increasing traffic to the offeror server 140, promoting the product or service to encourage purchase thereof or for establishing some form of relationship between the offeror and the user as a consumer.

Server system 110 comprises at least one processing device, and may comprise multiple processing devices operating in cooperation and/or parallel to operate web server functions 128 (e.g. using a hypertext transfer protocol daemon (HTTPD)), data processing functions and data storage and retrieval functions (e.g. using structured query language (SQL) support 132) in conjunction with database 130. Server system 110 may also comprise scripting language support 131, such as Microsoft™ ASP, ASP.NET or PHP.

Server system 110 may comprise or have access to suitable non-volatile data storage separate to database 130 for storing executable program code to enable server system 110 to perform its functions, including those functions described herein. Such program code comprises an operating system 124 and an information item management module 152 (as one of a number of software modules 150) for managing processing and communications functions in relation to the information items. Software modules 150 further comprise an averaging module 154 for determining average values based on user feedback received in relation to information items. Offeror server 140 and affiliate server 145 may comprise a similar architecture and similar server-related functions to server system 110, except that they will not have access to database 130.

Database 130 may comprise a localised or distributed database storing data records for the various information items, as well as user feedback (if any) received in relation to each information item. The time and date of user feedback received, for example in the form of positive or negative votes as to the efficacy or the redeemability of a promotional offer and any received user comments, is also stored in database 130. Database 130 may also be used by server system 110 to store data regarding the number of times an information item is selected and stores data for the purpose of rating, ranking or calculating values for the various information items according to user feedback and/or other measures of efficacy, user satisfaction, savings achievement, veracity or reliability of the promotional offers or other information items.

The affiliate server 145 may be hosted by or associated with an entity that tracks traffic and transactions to invoice the offeror and compensate the entity that operates server system 110 for sales that resulted from traffic referred through server system 110. For example, the entity hosting or associated with affiliate server 145 may be Commission Junction (www.cj.com), which provides affiliate marketing.

Referring in particular to FIG. 6, the example display 600 of a promotional offer 605 (as an example form of information item) is described in further detail. Display 600 may be displayed as one of a series of promotional offers 605, featured offers (not shown) and shopping tips (not shown) on a single page displayed using HTML and/or other program code executed by browser application 125.

Each promotional offer 605 comprises a display portion 610 and a feedback portion 620. The display portion 610 may comprise a promotional code 612, also referred to as a coupon code, and a description 618 of the promotion. The display portion 610 further comprises a statistical information display section 630 that provides information regarding the efficacy of the promotional offer 605 or shopping tip, for example including user success rate, user perceived reliability, aggregated positive and negative endorsements or votes from users, a color (or other) indication of the apparent efficacy of the information item or any other statistical information to assist a prospective consumer to assess the likelihood of successfully taking advantage of the promotional offer 605 or shopping tip (or e.g. software update, patch or plug-in).

In some embodiments, the statistical information 630 may comprise a histogram 632 representative of the historical user votes received in relation to the particular promotional offer 605 or shopping tip. The histogram 632 may comprise a number of bars displayed in series and indicative of the number and value (positive and/or negative) of user votes on the perceived reliability or redeemability of the promotional offer 605 or shopping tip over time.

The statistical information 630 may in some embodiments, be at least partly arranged in a brightly colored section of the display portion 610, including a prominent display of the success rate (e.g. 42%), the color indication and optionally the histogram 632. This brightly colored section may be displayed on an opposite side or end of the information item to the feedback portion 620.

Display portion 610 for promotional offers 605 may further comprise a Flash object 613, such as an empty Flash movie, that is transparent and overlaid on the promotional code 612. Alternatively, Flash object 613 may comprise one or more images that display the promotional code 612.

Feedback portion 620 comprises text 622 inviting feedback in relation to the promotional offer 605 or shopping tip or other information item and positive and negative voting buttons 624, 626. Feedback portion 620 may also comprise a selectable link or button 628 to display previously posted user comments in relation to the information item and allow qualified users to post further feedback.

Selection of a positive or negative voting button 624, 626 triggers served JavaScript or other code executing in browser application 125 to transmit a message to server system 110 indicating the Boolean status of the vote (yes/positive or no/negative), the time and date and an identification of the promotional code 612 or other identifier of the information item that is the subject of the feedback. Instead of the feedback message comprising the time and date of the vote, server system 110 may record the time and date at which the feedback message is received at the server system 110. One or more servelets executing on server system 110 then parse the messages and record all of the voting information received in such messages as voting data in database 130. Such servelets also set a vote flag on each information item record in database 130 for which a vote is received. Where an input value is also received for that information item, the information item record in database 130 also has an input flag set by the one or more servelets.

Selection of positive voting button 624 may trigger the execution of served script to generate an input solicitation window 700, described in further detail below.

Some embodiments may employ a modified feedback portion, in which only a single voting button 624 is provided instead of the two voting buttons 624, 626. This single voting button 624 is a positive voting button which, if selected, causes the input solicitation window 700 to be displayed. Thus, in some embodiments of system 100, the ranking score and average savings values of information items may be determined based on only a single type of voting feedback.

The example display 600 shown in FIG. 6 may be part of a list of displays of similar information items ordered according to a ranking score associated with each information item that is determined as described in U.S. patent application Ser. No. 12/554,350, the entire contents of which is hereby incorporated by reference. Promotional offers 605, such as coupons, shopping tips or other information items may be classified as being reliable or unreliable according to the ranking score. For example, information items having a positive ranking score (or otherwise being equal to or above a threshold level, such as zero or a mean or median ranking score, for example) may be considered to be reliable, while information items having a negative ranking score (or being below the threshold) may be grouped or classified as being unreliable, and these may be presented beneath an unreliable coupons banner indicating that the following items are considered to be unreliable. Alternatively, unreliable items may be displayed in a manner that visually distinguishes them from reliable items, such as different colours, borders or other graphical distinctions. Reliability or unreliability is intended to be an indicator of the prospects of successful use, redemption or veracity of the presented information items.

Because the reliability of the information item is determined according to the ranking score, which does not directly equate to a ratio of positive to negative votes, an information item may have a relatively high success rate, but still be ranked as being unreliable. For example, a promotional offer may be shown as having a high (e.g. 70%) success rate, but may be grouped beneath an unreliable coupons banner and displayed as an unreliable information item. A reason for why a promotional offer 605 is ranked as unreliable may be evidenced by the histogram 632 displayed for a given promotional offer 605, which may indicate that recent votes received in relation to this promotional offer 605 have been negative. As described in further detail in U.S. Ser. No. 12/554,350, the recency of votes affects a weighting to be attributed to the votes for determining the ranking score. In a contrasting example, a reliable promotional offer may be positioned above the dividing banner between reliable and unreliable items and shown as having a high (e.g. 73%) success rate. The histogram 632 of the promotional offer 605 may indicate many recent positive votes having been received in relation to that promotional offer, which in this example would be consistent with the overall 73% success rate (i.e. 73% of the total votes have been positive). It is possible, however, for a promotional offer 605 receiving recent positive votes to be ranked as reliable even though it has a relatively low (e.g less than 50%) overall success rate.

Where multiple promotional offers 605 are displayed in conjunction with promotional offer display 600, the promotional offers 605 are displayed in descending order of ranking score. Additionally, shopping tips may have ranking scores which position them intermediate one or more promotional offers 605. Shopping tips are generally scored, ranked and voted on in the same manner as promotional offers 605, including providing statistical information 630 and histograms 632 indicating recent voting history. While shopping tips display a selectable link instead of a promotional code 612, this link may direct the browser window 125 to a URL hosted by the server system 110 in the same manner as the selection of Flash object 613 as described above. Selection of the selectable link of a shopping tip would not, however, result in a copying of an offer or item code to the clipboard of the client computing device 120. In some embodiments, selectable links may be used instead of Flash objects 613, for example where it is not desired to copy an item code to the clipboard, but to simply open a new display to an external URL as described below.

As is illustrated in FIG. 6, promotional offer 605 also comprises a supplementary information bar or section 640, which in some embodiments may extend along a bottom section of promotional offer 605. Supplementary information section 640 may comprise an indication 642 of when the promotional offer 605 was posted onto the site. Further, the supplementary information section 640 may comprise a display of the average value 644 calculated for the promotional offer 605 in the manner described below. The average value 644 may be displayed as a dollar amount in average savings realised by the users calculated according to the input values previously provided via input value solicitation window 700. In alternative embodiments, the average value 644 need not be displayed as a dollar value in savings, but may indicate some other numerical or non-numerical rating or ranking generated based on aggregated user input received via input solicitation window 700.

A user selectable comment or feedback link 628 may also be provided as part of feedback section 620 and/or supplementary information section 640. In response to the selection of the user comment link 628, a drop-down display of prior user comments received in relation to the promotional offer 605 may be displayed, together with an invitation to the current user to provide feedback (if permitted according to user login requirements).

Display 600 of an information item, such as promotional offer 605, thus provides information (such as promotional code 612 and description 618) to enable the user to redeem, link to or otherwise take advantage of the information item, while also providing aggregated user feedback received in relation to the information item and providing a section by which a user may contribute their own input or feedback in relation to the information item. The aggregated user input may be based on filtered input that is filtered to eliminate received input values that are too big or too small from the average value calculation, thereby weeding out input values that may inappropriately skew the average value and provide a misleading indication of user feedback. For example, a user may accidently or inadvertently input a value of “100” instead of the intended input value of “10” and then submit that value without realising the error. In other instances, a user may purposefully or recklessly input a value that is too low or too high.

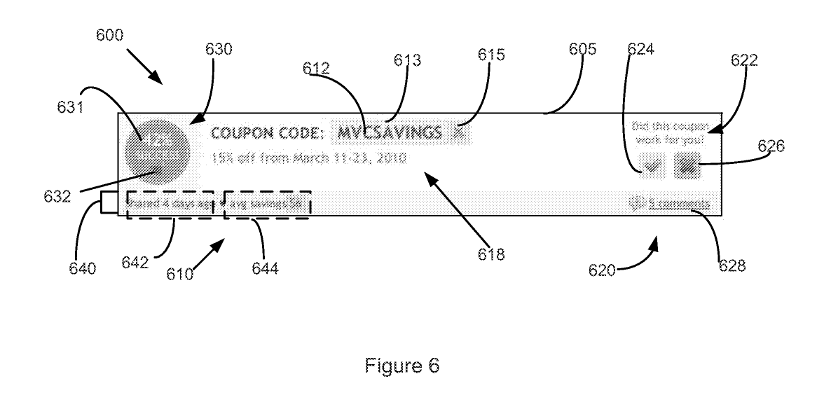

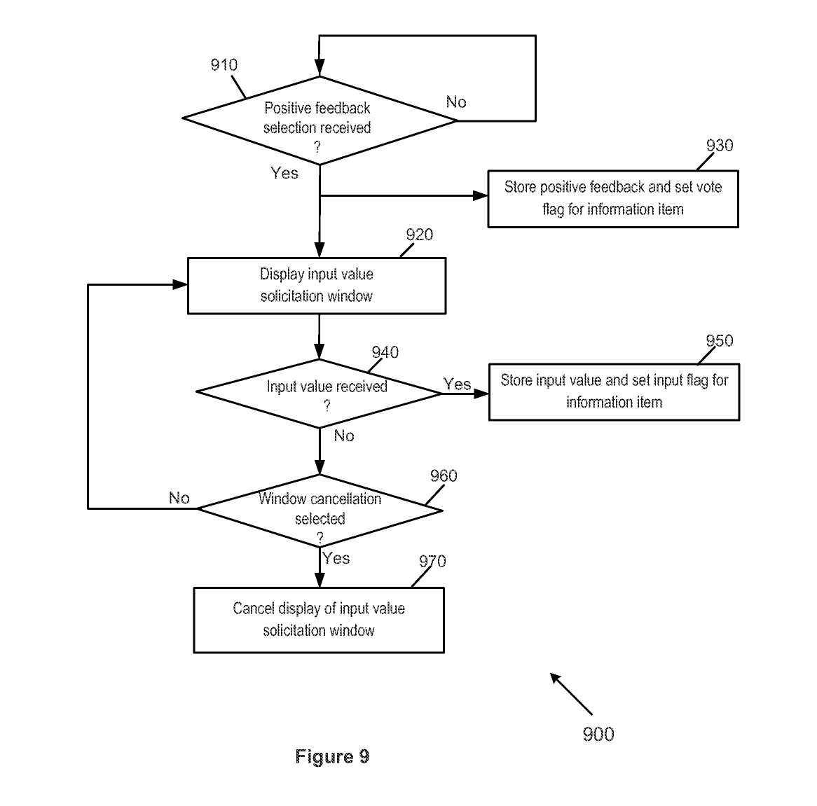

Referring in particular to FIG. 7, input value solicitation window 700 is described in further detail. A method 900 of receiving feedback via window 700 is described below with reference to FIG. 9. Window 700 is displayed in response to selection of positive voting button 624 or, in other embodiments, in response to another form of positive feedback in relation to the utility or efficacy of the displayed information item. Input value solicitation window 700 may comprise banner text 705, inviting the user to input a value, such as a dollar or other currency value, into input field 710. In other embodiments, input field 710 may be replaced by a list of values, buttons or other script-generated objects from which the user may select a particular value indicative of the amount that that user saved (i.e. using a promotional offer 605) or another value indicative of the efficacy, redeemability or reliability of the information item.

Input value solicitation window 700 also comprises a selectable submit button 713 to trigger the sending of the value input into field 710 (or otherwise provided by user input) to the server system 110 via a client-side applet executed by browser application 125. Alternatively, the user may select a cancellation option 714 to decline to provide an input value. Selection of the cancellation option 714 may result in the input solicitation window 700 being closed and no longer displayed by the browser application 145.

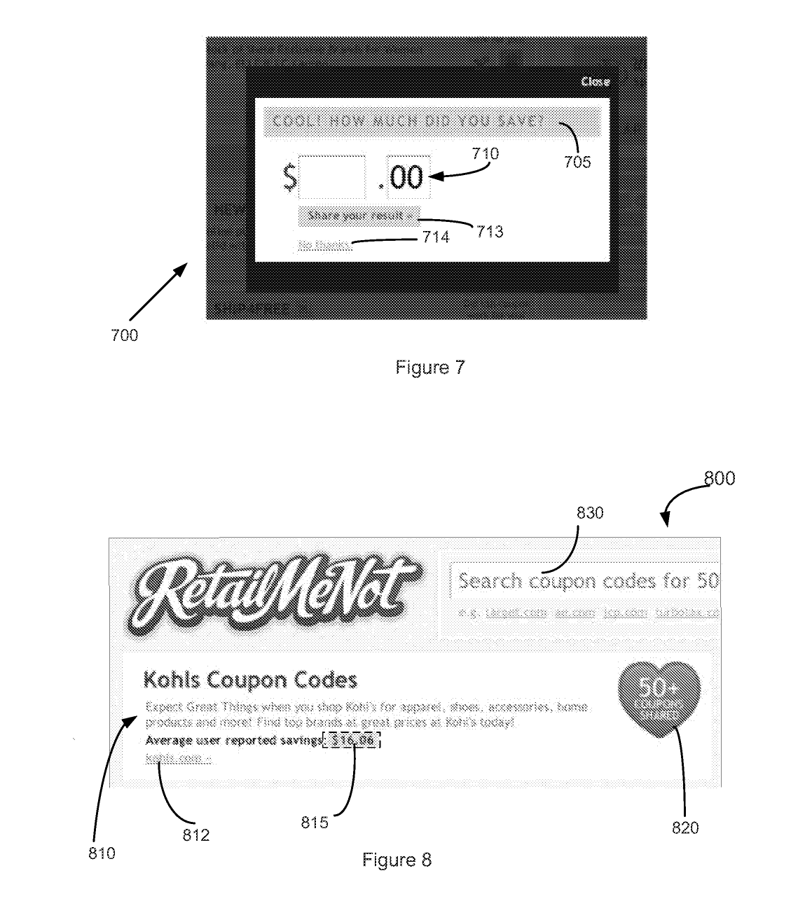

Referring in particular to FIG. 8, an example display 800 of a top banner area for a list of information items is described in further detail. Display 800 may be provided as part of a page displaying a number of displays 600 of information items, such as promotional offers 605, for example. Display 800 may be an offeror specific display generated in response to a selection or other user input to display a group of information items for a specific offeror. In the example of promotional offers, the offeror may be an offeror of a number of promotional offers 605 which are displayed below, or otherwise in association with, the banner display 800. The displayed promotional offers 605 may comprise a selection of top-ranked promotional offers, for example.

Banner display 800 comprises a general description section 810 in which a general description of the offeror and/or information items is provided, together with an indication of aggregated user input, for example in the form of an average value (group average) 815, which may indicate average user reported savings for a group of (i.e. all or a selection of) current or historical promotional offers 605 offered by the offeror. Description section 810 may also comprise a link 812 to a site of the offeror to which the banner display 800 relates. The offeror-specific average value 815 may thus provide a value of aggregated user input received across a number (i.e. a group) of information items provided by a particular offeror.

In some instances, the offeror-specific average value 815 may be calculated as the average of all stored average values of filtered input values for all of the information items associated with the offeror in relation to which the offeror-specific average value 815 is displayed. In other embodiments, unfiltered or selectively filtered input values may be used to calculate the offeror-specific average value 815.

Reference herein to calculation of an average value includes calculation of a mean, median or mode value. Such mean value calculations may include arithmetic mean, geometric mean and harmonic mean value calculations, as well as quadratic mean, generalized mean, weighted mean, truncated mean, interquartile mean and winsorized mean calculations, for example. For purposes of illustration and by way of non-limiting example, methods described below may employ a version of truncated mean calculation, which involves the calculation of an arithmetic mean of data values remaining after a certain number or proportion of the highest and lowest data values are ignored or disregarded (i.e. for seeming to be too high or too low). However, the truncated mean calculation as herein described does not necessarily require any of the received input values to be ignored if they are not outside the acceptable value range defined by the upper and lower thresholds.

In some embodiments, the group average value 815 may effectively be calculated as a median value of mean values calculated for each information item. In other embodiments, the group average value 815 may effectively be calculated as a mean value of median values calculated for each information item. Similarly, other combinations of mean, median and mode averages may be used in determining the average values for individual information items and for groups of such information items. The group average values 815 thus calculated may, in some instances, be calculated on the basis of all received input values for each information item in the group, rather than only on those input values determined to not be unreliable according to the methodology described below.

In some embodiments, banner display 800 may be displayed in conjunction with one or more promotional offers 605, but only the group average value 815 may be displayed. That is, in such embodiments, each promotional offer 605 may not also display the average value 644 calculated for that promotional offer 605. In such embodiments, each promotional offer 605 may still have an average of the input values calculated for it, based on filtered ones of those input values, but the average would not be displayed and might be used solely as the basis for calculating the group average value 815. In other embodiments, filtration of the input values may be performed for each information item, but without also calculating an average value of the filtered input values for that information item prior to calculating the group average value 815.

As illustrated in FIG. 8, banner display 800 may provide a search input field 830 for receiving text-based search terms. Search input field 830 may be used by the user to look for information items provided by other offerors, for example. Banner display 800 may also comprise an information item quantity indicator 820, indicative of the number of information items provided or presented by the offeror. Quantity indicator 820 may be representative of the number of information items displayed in a historical sense over a long period of time or may only indicate the number of information items that are currently viewable (i.e. those that have not been expired, removed or determined to be too unreliable for display). Information item quantity indicator 820 may be provided adjacent or in-line with the information section 810 in a prominent position within display 800. In some embodiments, group average value 815 may be co-located with, or substituted for, item quantity indicator 820 in the prominent display position.

Although not shown, the offeror-specific average value 815 may be displayed in conjunction with other offeror-specific displays or sub-displays, for example within a page that features a number of offerors and a separate offeror-specific average value 815 for each offeror. This aggregated user feedback can then allow users to judge the likelihood of achieving a successful or positive outcome in taking advantage of information items offered by a particular offeror from among a number of possible offerors of interest, thereby improving the user experience of the information item sharing site.

In all instances in which an average value is displayed, the displayed value may be a whole number rounded up or down from the actual calculated average value. The displayed average value therefore need not be an exact average value.

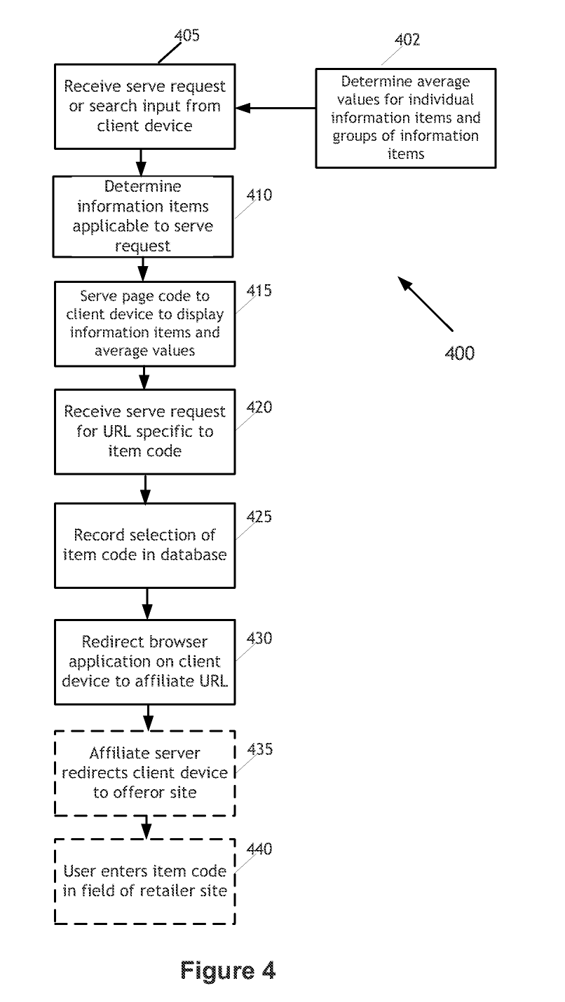

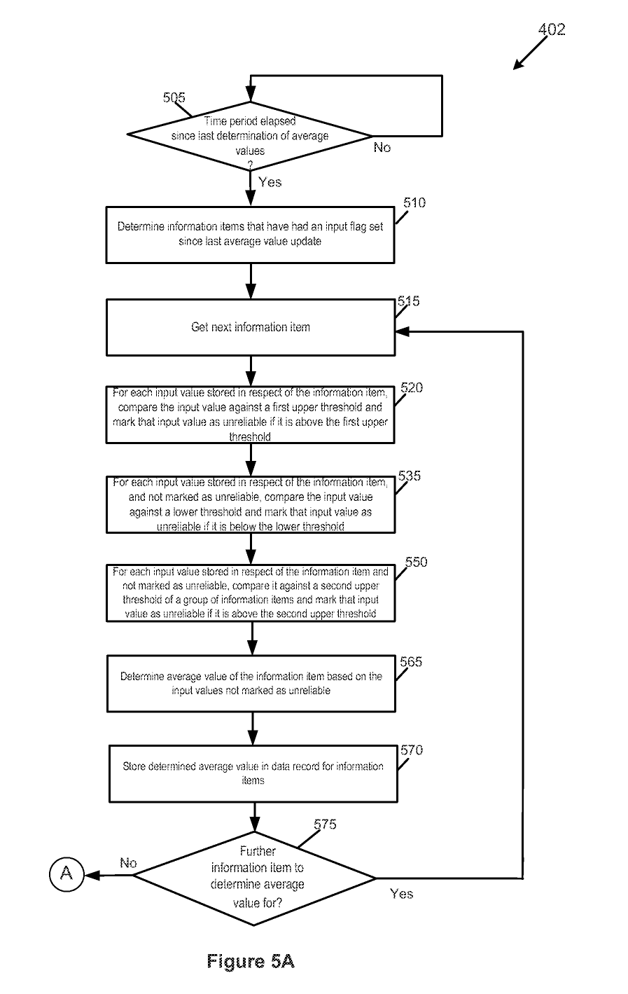

Referring now to FIG. 4, a method 400 for ranking promotional offers 605 for display is described in further detail. Method 400 begins at step 402, at which the server system 110 determines average values for the various stored information items and for all information items grouped according to offeror, based on user input received in relation to the information items. Methods performed as part of step 402 are described in further detail below, with reference to FIGS. 5A and 5B.

At step 405, server system 110 receives from client browser application 125 a page request (e.g. by specifying a URL hosted by server system 110 or by providing search or selection input) where the requested page comprises one or more information items such as a promotional offer 605 or multiple promotional offers 605. This serve request is sent via network 115 and may effectively include one or more search criteria (e.g. via search input field 830, FIG. 8) or selection input, such as an offeror-specific link. For example, the criterion or selection input may relate to a specific information item offeror and the responsive display of information items may then comprise information items offered, sponsored or authored by that offeror.

At step 410, server system 110 queries the database 130 in response to the serve request to determine the information items applicable to one or more DCC-3099729 application 21 criteria provided with the serve request. If no search or selection-based criteria is specified in the search request, then a default criterion may be used. For example, if the serve request is directed to a general URL of the server system 110, there may be a default criterion applied to that URL such as “display top 20 information items with the highest ranking scores”.

At step 415, in response to the serve request, server system 110 serves page code to client browser application 125 over network 115. The page code includes HTML code and applets and/or JavaScript to provide one or more displays, for example including display 600, 700 and 800. This page code is then executed by the client browser application 125 to display images and/or text for one or more information items, such as promotional offers 605 or shopping tips, as part of display 600. The HTML code to provide one of the promotional offers 605 may have approximately the following form:

```
<div class=“coupon” id=“123456”>
  ...
  <td class=“code”>FREE100</td>
  <td class=“discount”>Get Free Shipping off your
$100 Purchase</td>
  ...
</div>
```

Execution of the page code also inserts or embeds Flash object 613, e.g. <embed src=“clicktocopy.swf?code=FREE100”/>. Voting buttons 624, 626 are embedded as selectable objects within display 600 which, when executed, cause execution of a script to provide a message containing voting information to be sent to server system 110. If positive voting button 624 is selected, indicating that the user had a positive experience in relation to the information item, then this triggers execution of a script (served with the page code) by browser application 125 to display input value solicitation window 700.

Execution of the page code also causes the average value 644 (determined at step 402) for each information item 605 to be displayed in supplementary information bar or section 640, which may be positioned to extend along the bottom of the information item 605. The average value 644 may be a savings value, for example where the information item relates to a promotional offer in the form of a coupon or special offer, and may be displayed as a dollar (or other currency) amount along with other information and preceded by text such as “Avg savings:”.

Where the search criterion or selection input corresponds to a group of information items, such as a plurality of promotional offers 605 offered by a selected offeror, the display of the served page code at step 415 may also comprise the offeror-specific banner display 800 that includes a display of an average value 815 of information items for the displayed group of information items offered by that offeror.

In some embodiments, a total value, such as total savings, may be calculated based on the filtered input values and the total displayed instead of, or in conjunction with, the average value for an information item or the average value for a group of information items.

Optionally, as part of step 415, the page code served by server system 110 to client computing device 120 may contain code to execute display of the information items in a particular order, with the information items to be displayed being those selected from the top results returned from the query of database 130 at step 410, ordered with the information item having the highest ranking score to be displayed at the top of the page, with the remaining information items being displayed in descending order. Alternatively, where there are two or more item groups, the information item with the highest ranking score among the first group is displayed at the top of the page, with the information item with the highest ranking from among the items in the second item grouping being displayed just below the information item with the lowest score from among the first item grouping.

In response to serving the page code to client computing device 120, server system 110 may receive further serve requests specifying search or selection criteria to cause the display of further information items, in which case steps 405 to 415 are performed again for such serve requests. Alternatively, server system 110 may receive a serve request corresponding to selection of a link at the client computing device 120, for example if a user wishes to take advantage of the presented information item.

Once a link or other linking object, such as Flash object 613 (displaying or overlying the promotional code 612), has been selected, an ActionScript code segment may automatically copy the promotional code 612 (e.g. “FREE100” or “MUCSAVINGS”), if one is provided, to the clipboard or other user-accessible temporary storage of the client computing device 120. Simultaneously or immediately after the copying, client browser application 125 executes the ActionScript (or JavaScript called by the ActionScript) of Flash object 613 to open a new client browser window using the same client browser application 125. Alternatively, the ActionScript or JavaScript may cause a new browser display to be provided over the previous display instead of opening an entirely new window. This may be desirable where, for example, the client computing device 120 has a relatively small visual display area, such as for mobile handheld devices, that may become too crowded if more than one browser window is open.

The new client browser window or display is opened at step 420 with a URL (e.g. http://www.serversystemURL.com/out/?coupon=123456) passed to client device 120 with the page code, automatically directing the client browser application 125 to transmit a serve request to a URL hosted by server system 110. This URL may be specifically associated by server system 110 with the promotional code 612 or another identifier or code allocated by server system 110 to the information item and may include the promotional code 612 or other item code or identifier as part of the URL. Direction of the serve request to this specific URL allows the server system 110 to recognise that a link from the information item has been selected and to record this event at step 425 for tracking purposes.

As part of step 425, server 110 then performs a look-up, for example in database 130, to determine a special URL provided by an affiliate server 145 to enable tracking of traffic to the offeror server 140 via server system 110. The affiliate URL may not always be found by the look-up.

If the look-up is successful, then at step 430 server system 110 redirects the new client browser window or display in browser application 125 to the special affiliate URL hosted by the affiliate server 145, which may record the corresponding serve request as being associated with server system 110, so that acknowledgement or reward can be provided for the client referral through server system 110. If the affiliate URL cannot be found, a URL associated with offeror server 140 may be used instead.

Following step 430, affiliate server 145 automatically redirects the new window of the client browser application 125 to a suitable URL hosted by the offeror server 140, at step 435. The offeror server 140 may then serve page code to browser application 125 relating to the promotional offer or other information item or the product or service to which the selected information item relates. The redirections at steps 430 and 435 occur automatically without user input and may not be visible unless displayed by the browser application 125 in the http address field.

At the user's option, the user may directly paste the coupon code stored in the clipboard or other user accessible memory into a field on a page hosted by offeror server 140 to thereby claim or redeem the promotional offer, for example as part of an online purchase procedure. This pasting may be performed at step 440 using a suitable user interface feature provided by the client computing device 120, such as a key combination shortcut via a keyboard or via a drop down menu option, for example provided by the web browser application 125 or via a hot key or right click.

In alternative embodiments, step 420 may involve receipt of the serve request at an affiliate URL instead of the server system URL, thereby bypassing the client system 110 and sending the serve request directly to affiliate server 145. As the affiliate URL is a specific URL assigned for use by server system 110, this URL can be used by affiliate server 145 to track traffic referred through server system 110. In such alternative embodiments, steps 425 and 430 are not performed and the modified step 420 is followed by step 435.

Referring now to FIG. 5, process performed according to step 402 of method 400 is described in further detail. The process begins, in some embodiments, at step 505, at which the averaging module 154 checks a time elapsed since the last average value update. If the time period, which may be a set period of about 15 minutes up to 24 hours or another fixed time period, has elapsed, then at step 510, the averaging module 154 performs a query of database 130 to determine information items that have had an input flag set since the last average value update procedure. These information items will have had an input flag set when a positive vote was received and then an input value received (via input field 710 of window 700) in respect of that information item after the last average value update. The query thus only needs to check for flagged information item records at step 510.

At step 515, averaging module 154 gets the next information item (which may be the first) for which an input flag has been set. At step 520, averaging module 154 compares each input value stored in relation to the information item against a first upper threshold. The first upper threshold may be a dynamic threshold, for example set as a fixed proportion (e.g. 300% or another fixed proportion greater than the second upper threshold) of the average of all other input values received and stored in relation to the information item and not marked as unreliable. This means that the actual value of the first upper threshold may be different for each input value under consideration. For example, for received input values X, Y and Z, input value X will be compared against the average of values Y and Z and, if X is greater than a fixed proportion of the average of Y and Z, then the result of the comparison is that input value X is determined to be above the first upper threshold. For each input value that is determined to be above the first upper threshold, that input value is marked as unreliable as part of step 520. Thus, step 520 involves marking as unreliable all input value that exceed the fixed proportion when compared to the average of other input values not yet marked as unreliable. The fixed proportion for the first upper threshold may be between, say 200% and 1000% for example, and a specific value of the fixed proportion may be selected for optimised filtering.

Once an input value is marked as unreliable, it is no longer used in any part of the comparison (filtering) processes executed as part of the current iteration of step 402, although that input value remains stored for use in subsequent average value calculations to the extent that it is not again marked as unreliable.

At step 535, averaging module 154 performs a comparison of each input value stored in respect of the information item (and not yet marked as unreliable) with a lower threshold. If the input value under consideration is below the lower threshold, which may be a fixed proportion of the average of the remaining (not unreliable) input values, then that input value is marked as unreliable for being too small and is removed from further consideration. The fixed proportion that defines the lower threshold may be between about 25% and 75%, say 50%, for example, or another number that is more than 0% but less than 100% of the average of the input values not yet marked as unreliable.

The lower threshold and first upper threshold may be selected to be proportionally symmetric or asymmetric about each calculated average value (i.e. central tendency). That is, the lower and first upper thresholds may be, say, half (50% or 2⁻¹) and twice (200% or 2¹) the average (central tendency) value, for example, in which case they would effectively be proportionally symmetric about the calculated average value. On the other hand, the lower and first upper thresholds in the examples given herein of half (50% or 2⁻¹) and three times (300% or 3¹) the calculated average (central tendency) value would be proportionally asymmetric about the calculated average value.

At step 550, averaging module 154 performs a comparison of each input value stored in respect of the information item and not yet marked as unreliable with a second upper threshold of a group of information items, such as all information items provided by a particular offeror. As part of step 550, where averaging module 154 determines that an input value exceeds the second upper threshold, then that input value is marked as unreliable. The second upper threshold may be a fixed proportion, for example between 150% and 250%, say 200%, or another value less than the first upper threshold but greater than the average of the previously stored average of average values of information items that are part of the group to which the information item now under consideration belongs.

In some embodiments, the lower and first and second upper thresholds may be specified with reference to the standard deviation (or other dispersion about a central tendency) of the received input values. For example, the first upper threshold may be set at about 2 standard deviations above the mean, with the second upper threshold being, say 1.7 standard deviations and the lower threshold being, say 1.7 to 2 standard deviations below the mean. Thus the thresholds need not be fixed as a percentage value of an arithmetic mean, but may use other measures of apparent consistency with the remainder of the sample population (i.e. received input values).

At step 565, averaging module 154 determines the average value of the information item question based on the input values not marked as unreliable. The determined average value is then stored at step 570 in a data record of, or associated with, the information item in question.

Thus, the filtering process performed in steps 520, 535 and 550 effectively filters out input values that are either too small or too large relative to the other input values received or are too large relative to the average of average values across all information items within a group, such as all information items offered by a specific offeror. This filtering process therefore allows an average value to be calculated for an information item and for groups of information items that is not unduly skewed by an erroneously input value or an intentionally understated or overstated value. The average value thus stored and displayed is one in which the user can have confidence as to its accuracy as an indicator of the approximate quantum of savings that can be achieved under a promotional offer, where the average value is a savings value.

For purposes of illustration, let us consider a series of received input values 5, 15, 1 and 6 and suppose that the average value is calculated as a truncated arithmetic mean. In this example, the first upper threshold will be set at 300% of the average of the other input values, the lower threshold will be set at 50% of the average of the other input values and the second upper threshold will be set at 200% of the average of all previously calculated average values for information items offered by the same offeror as the information item under consideration. In step 520, the first value, 5, is compared against the average of the values 15, 1 and 6 (i.e. 15+1+6, divided by the number of the values, 3, which equals 7.33) and will be found to not be more than 300% of 7.33, so that value 5 will not be marked as unreliable. Next, the value 15 will be compared against the average of the other three values 5, 1 and 6 (which equals 4) and 15 will be found to be greater than 300% of 4 and therefore marked as unreliable. Next, the value 1 will be compared against the average of the remaining values 5 and 6 (15 having been removed from consideration as being unreliable). The value 1 will be found to not exceed 300% of the average (5.5) of values 5 and 6 and will therefore not be marked as unreliable at this stage. Finally, the value 6 will be compared against the average of values 5 and 1, which is 3 and will be found to not exceed 300% of 3. The value 6 will therefore not be marked as unreliable. With all of the values having been compared against the first upper threshold, the remaining (not unreliable) values are compared against the lower threshold at step 535. Thus, the value 5 is compared against the average of values 1 and 6, which is 3.5 and will not be found to be less than 50% of 3.5 and so is not marked as unreliable. Next, the value 1 is compared against the average of values 5 and 6, which is 5.5 and will be found to be less than 50% of 5.5. The value 1 will therefore be marked as unreliable and excluded from further consideration. The value 6 is then compared against the average of the remaining values, which includes only the value 5. The value 6 will not be found to be less than 50% of 5 and will therefore not be marked as unreliable. Therefore, the result of steps 520 and 535 in filtering received input values 5, 15, 1 and 6 is that values 15 and 1 are marked as unreliable and are not included in the calculation of the average value for the information item in respect of which they were received. Assuming that neither of those values is greater than the second upper threshold, as determined at step 550, the average value thus displayed for that information item will be 5.5, being the average of values 5 and 6.

In a further example, let us suppose that a new value 10 is received in relation to the same information item, with the result that the process of steps 520 and 535 are performed in relation to the series of values 5, 15, 1, 6 and 10. Iterating through the process described above in a similar manner (applying the same upper and lower thresholds) with this expanded input value set would result in only the value 1 being excluded for being too small. The value 15 would no longer be considered to be too big. Thus, it can be seen that stored input values may sometimes be marked as unreliable, but may subsequently be factored into the average value calculation when further input values are received and the average value is re-calculated. Also, the greater the number of input values received for an information item, the more accurate the filtering process becomes.

An example of code that may be employed to give effect to the described method of filtering the input values is provided below, in the context of user-reported savings achieved using coupons:

$result = dbPlodderExec(“SELECT * FROM savings ORDER BY coupon
DESC, amount ASC”);
while($row = mysql_fetch_assoc($result)) {

$all[$row[‘site’]] [$row[‘coupon’]] [ ] = $row[‘amount’];

}
// discard savings that are more than 300% of the coupon average
while (list($siteId, $coupons) = each($all)) {

while (list($couponId, $couponSavings) = each($coupons)) {

while (list($key, $saving) = each($couponSavings)) {

if(count($couponSavings) > 1) {

$movingAverage =
(array_sum($couponSavings)−$saving) /

(count($couponSavings)−1);

} else {

$movingAverage = $saving;

}
if($saving < ($movingAverage*3)) {

$all2[$siteId] [$couponId] [ ] = $saving;

}

}

}

}
// discard savings that are less than 50% of the coupon average
while (list($siteId, $coupons) = each($all2)) {

while (list($couponId, $couponSavings) = each($coupons)) {

while (list($key, $saving) = each($couponSavings)) {

if(count($couponSavings) > 1) {

$movingAverage =
(array_sum($couponSavings)−$saving) /

(count($couponSavings)−1);

} else {

$movingAverage = $saving;

}
if($saving > ($movingAverage/2)) {

$all3[$siteId] [$couponId] [ ] = $saving;
$siteSavings[$siteId] [ ] = $saving; // store for next
step

}

}

}

}
// discard savings that are more then 200% of the group
(merchant) average
while (list($siteId, $coupons) = each($all3)) {

$siteAverate = array_sum($siteSavings[$siteId]) /

count($siteSavings[$siteId]);

while (list($couponId, $couponSavings) = each($coupons)) {

while (list($key, $saving) = each($couponSavings)) {

if($saving < ($siteAverate*2)) {

$all4[$siteId] [$couponId] [ ] = $saving;
$siteSavings2[$siteId] [ ] = $saving; // store for next

step

}

}

}

}
// store
while (list($siteId, $coupons) = each($all4)) {

$siteAverate = array_sum($siteSavings2[$siteId]) /

count($siteSavings2[$siteId]);

if(count($siteSavings2[$siteId]) > 2) dbPlodderExec(“UPDATE

LOW_PRIORITY site SET avgSavings = ‘“.$siteAverate.”’ WHERE
siteId = ‘“.$siteId.”’”);

while (list($couponId, $couponSavings) = each($coupons)) {

$totalCouponSavings = array_sum($couponSavings);
$couponAvgSavings = array_sum($couponSavings) /

count($couponSavings);

if($couponSavings > 2) dbPlodderExec(“UPDATE
LOW_PRIORITY

coupon SET savings = “.$totalCouponSavings.”, avgSavings =
‘“.$couponAvgSavings.”’ WHERE couponId = ‘“.$couponId.”’”);

}

}

At step 575, averaging module 154 determines whether there is a further information item for which an updated average value has not yet been calculated and, if so, repeats steps 515 to 570 for the next information item. Otherwise, process 402 proceeds to steps 580 to 595 to determine average values for groups of information items and the process 402 will be repeated again once the time period elapses again.

The flags set for the information items that have had an updated average value calculated are reset or turned off at step 597 after it is determined at step 595 that there are no more groups of information items to check.

At step 580, averaging module 154 determines, for each group of related information items (i.e. all information items associated with a particular offeror) whether any information items in the group has received an input value since the last update procedure. This is determined by checking for an input flag set in one of the information items belonging to the group, for example. At step 585, averaging module 154 then determines for each group whether to update the average value for that group. If the average value is to be updated, then at step 590, averaging module 154 recalculates the average value for the group of information items based on the stored average values for each information item in the group and then stores the recalculated average value in a data record associated with that group of information items. The data record may be the data record for the offeror, for example.

If at step 585 it is determined that no updating of the average value is required for a group, or if a recalculation for a group has been done at step 590, then averaging module 154 checks at step 595 whether there is another group of related information items to check as to whether the average value for that group should be updated. If there is another group to check, then steps 580 to 595 are repeated or, if not, then averaging module 154 resets the input flags at step 597 and returns to step 505.

In alternative embodiments, determination of average values for information items may occur on-the-fly, so that as soon as an input value is received for an information item via input value solicitation window 700, its new average value is calculated based on all of the input values received for that information item and filtered as described herein. In such embodiments, steps 505 to 515 may be replaced by a step in which averaging module 154 determines that a vote has been received for a particular information item and then performs steps 520 to 570 for that information item, then performs step 590 for the group of information items to which the affected information item belongs. In such embodiments, it is not necessary to set input flags in an information item data record when a new input value is received for that information item.

In some embodiments, the averaging module 154 may be programmed so that, instead of calculating and displaying an arithmetic mean of the filtered input values in relation to information items, the median of the filtered input values is calculated and displayed. Similarly, the average of the average values for a group of information items may be a median of the average values or a median of the median values.

Referring now to FIG. 9, a method 900 of receiving user feedback in relation to a displayed information item is described in further detail. Method 900 begins at step 910, where it is determined (according to served code) whether positive user feedback is received, for example in the form of a selection of positive voting button 624, when an information item, such as a promotional offer 605, is displayed as part of step 415.

Once it is determined that a positive feedback selection has been received at step 910, then the served code executed by browser application 125 causes the display of input value solicitation window 700 at step 920. Also responsive to the same feedback selection trigger, served code, such as an applet, transmits a message to server system 110 to store the positive feedback and set the vote flag in relation to the information item for which the positive feedback was received. This sending of a message to server system 110 is performed at step 930.

Step 940 involves determining whether an input value is received via input value solicitation window 700 (for example by the user typing in a numerical value in field 710). If an input value is received at step 940, then served code executing in browser application 125 sends a message at step 950 to server system 110 to store the input value and set the input flag for the information item that is the subject of the positive feedback. If no input value is received at step 940, then, if no window cancellation selection is received at step 960, the window 700 continues to be displayed at step 920. Otherwise, the display of the input value solicitation window 700 is cancelled at step 970 in response to the cancellation selection at 960.

In this description, the term “Flash object” or similar terms, is intended to indicate an electronic media object, for example having a .swf extension, according to the Adobe™ Flash specification. Additionally, the references to JavaScript and ActionScript are intended to be understood as examples of client-side script executable in a browser application and are not intended to be limiting. Other scripting languages may be used, to the extent that they are capable of performing the functions described herein. Embodiments are described herein by way of example, with reference to the drawings. The embodiments are intended to be provided by way of non-limiting example and some modifications of the described embodiments may be apparent to those of ordinary skill in the art without departing from the spirit and scope of the embodiments.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1-44. (canceled)

45. A server system configured to determine the efficacy of offers, the system comprising:
memory storing instructions; and
one or more processors communicatively coupled to the memory, wherein the instructions, when executed by the one or more processors, cause a server system to perform operations comprising:
sending offers for presentation to a user;
receiving a selection by the user of an offer among the sent offers;
after receiving the selection, sending to the user an interface by which the user indicates that the user is interested in the offer;
receiving an indication that the user is interested in the offer;
after receiving the indication, sending to the user an interface by which the user enters an amount saved with the selected offer;
receiving a user-entered amount saved;
calculating a first upper threshold based, at least in part, on previous amounts saved entered by a plurality of other users;
after receiving the user-entered amount saved, determining whether the user-entered amount saved is less than the first upper threshold;
responsive to determining that the user-entered amount saved is less than the first upper threshold, calculating an average amount saved based, at least in part, on the user-entered amount saved; and
presenting offers to another user along with the calculated average amount saved.

46. The system of claim 45, wherein calculating a first upper threshold based, at least in part, on previous amounts saved by a plurality of other users comprises:
calculating the first upper threshold based on previous amounts saved by the plurality of other users by using the selected offer.

47. The system of claim 45, wherein the instructions when executed further cause the server system to perform operations comprising:
calculating a second upper threshold, based, at least in part, on previous amounts saved by using a plurality of offers from the offeror of the selected offer.

48. The system of claim 45, wherein the instructions, when executed, cause the server system to perform operations comprising:
periodically determining whether a new user-entered amount saved has been received, and responsive to the determination that a new user-entered amount saved has been received, performing the step of:
calculating the first upper threshold based, at least in part, on previous amounts saved entered by a plurality of other users; and
calculating the average amount saved based, at least in part, on the user-entered amount saved.

49. The system of claim 45, wherein the first upper threshold changes dynamically as additional user-entered amounts saved are received.

50. The system of claim 45, wherein the instructions, when executed, cause the server system to perform operations comprising:
calculating a second upper threshold based, at least in part, on previous amounts saved entered by a plurality of other users, wherein the first upper threshold is based on amounts saved by using one offer from a merchant, and wherein the second upper threshold is based on amounts saved by using any of a plurality of offers from the merchant.

51. The system of claim 45, wherein the instructions, when executed, cause the server system to perform operations comprising:
after receiving the selection, sending to the user instructions that, when executed on a user device, cause the user device to store a value identifying the server system and navigate a web browser to a website of the offeror.

52. A method of determining the efficacy of offers, the method comprising:
obtaining a plurality of offers by an offeror;
for each of the offers, obtaining a plurality of user-feedback values indicating an amount saved by using the respective offer;
for each of the offers, calculating, with one or more processors, a respective offer-filter criterion indicative of unreliable user-feedback values provided by users for the amount saved by using the respective offer;
calculating an offeror-filter criterion indicative of unreliable user-feedback values for the amount saved by using any of the plurality of offers; and
calculating a measure of central tendency (MCT) of amount saved by users using any of the plurality of offers by excluding from the calculation of the MCT of amount saved both those user-feedback values that fail to satisfy their corresponding offer-filter criterion and those user-feedback values that fail to satisfy the offeror filter criterion.

53. The method of claim 52, wherein the offeror-filter criteria includes a threshold that is proportional to a previously calculated MCT of amount saved.

54. The method of claim 52, comprising:
sending the MTC of amount saved to a user device along with a plurality of offers from the offeror and instructions that cause the user device to display the average amount saved and the plurality of offers.

55. The method of claim 52, wherein each of the offer-filter criterion is updated dynamically after new user-feedback values for the corresponding offer are received.

56. The method of claim 52, comprising calculating an updated MCT of amount saved after calculating the MCT of amount saved, wherein the updated MCT of amount saved is based, at least in part, on user-feedback values that previously failed to satisfy their corresponding offer-filter criterion and that satisfy an updated corresponding offer-filter criterion.

57. The method of claim 52, wherein the MCT of amount saved is an average amount saved.

58. The method of claim 52, comprising:
receiving a request for offers from a requesting user device; and
sending at least some of the plurality of offers to the requesting user device along with the MCT of amount saved for display on the user device.

59. A method of calculating a representative amount saved by using offers from a merchant based on potentially unreliable user-reported savings, the method comprising:
obtaining a plurality of user-reported savings values, each corresponding to one of a plurality of offers from a merchant;
filtering, with a computer, from the plurality of user-reported savings values, outliers relative to other user-reported savings values associated with the same offer;
filtering, from at least some of the plurality of user-reported savings values, outliers relative to user-reported savings values associated with any of the offers; and
calculating a measure of central tendency among the user-reported savings values remaining after filtering.

60. The method of claim 59, comprising:
calculating upper and lower thresholds for each of the plurality of offers,
wherein filtering, with a computer, from the plurality of user-reported savings values, outliers relative to other user-reported savings values associated with the same offer comprises:
excluding from the calculation of the measure of central tendency those user-reported savings values outside of the range specified by the corresponding upper and lower thresholds.

61. The method of claim 60, wherein the upper and lower thresholds are asymmetric about a corresponding average amount saved for the corresponding offer.

62. The method of claim 59, wherein filtering, from at least some of the plurality of user-reported savings values, outliers relative to user-reported savings values associated with any of the offers comprises:
dynamically calculating threshold values that change over time after additional user-reported savings values are obtained.

63. The method of claim 59, comprising sending the calculated measure of central tendency and a plurality of offers by the merchant to a user requesting offers relating to the merchant, wherein the measure of central tendency is a truncated mean value.

64. The method of claim 59, wherein the measure of central tendency is an aver
